(19) United States
(12) Patent Application Publication
(10) Pub. No.: US 2009/0266222 A1
(43) Pub. Date: Oct. 29, 2009

(54) Notation system for music,displaying pitches in color on a keyboard chart and having rhythmic values indicated by the vertical length of said pitches

(76) Inventor: Noah Ernest Epstein, Halifax (CA)

Correspondence Address: Noah Epstein, 6116 Charles Street, Halifax, NS, B 3K 1L3, CA

(21) Appl. No.: 12/321,849

(22) Filed: Jan. 27, 2009

Related U.S. Application Data
(60) Provisional application No. 61/125,290, filed on Apr. 24, 2008.

(51) Int. Cl. G09B 15/02

(52) U.S. Cl. 84/483.2

(57) ABSTRACT

A method of notating music which displays pitches on a pitch chart, which can be displayed in various embodiments with a range of features including: different colors for each semitone of the octave, a keyboard chart displaying rhythmic value by the vertical height of the notes, a diverse shading of notes to illustrate whether they are to be played at a high sound level or instead at a low volume, and further features of harmonic, melodic, and theoretical analysis.

### CROSS-REFERENCE TO RELATED APPLICATIONS

This application claims the benefit of provisional patent application Ser. No. 61/125290, filed 2008 Apr. 24 by the present inventor.

### FEDERALLY-SPONSORED RESEARCH

Not Applicable

### SEQUENCE LISTING OR PROGRAM

Not Applicable

### BACKGROUND

1. Field

This application is related to music, specifically to music notation for music using the 12-semitone octave.

2. Prior Art

There are many problems with the way that music is notated with the standard notation system today, which displays notes on a 5-line staff. Many different attempts have been made to change or improve the musical notation system, but arguably no known system has yet produced the ability for a performer to simply play a piece of music if they have very little knowledge of how music notation works. The display of pitches from top to bottom of a staff, and rhythm running from left to right often causes confusion for the beginner, and many alternative notations fail to correct this, instead offering different shapes for note-heads and/or different numbers of lines of the staff or further features which often seem confusing and arbitrary to a beginner musician. Klavarscribo has offered a 90 degree clockwise rotation of the standard musical system which puts pitches horizontally and rhythm vertically, as is also seen in the proposed system of this application. However, the notation system proposed in this application arguably has many benefits beyond what other alternatives such as Klavarscribo have offered, which will be further explained in this document. There are various patents for existing alternative music notation systems, however they do not offer the same system as this current application does. For example, the use of color to denote musical pitches of a scale has been explored by Bonham in U.S. Pat. No. 6,831,219, the “Chromatic music notation system”, however, this system assigns a different order of colors to each pitch than does this application. A further example of different use of color in a music notation system is Kestenbaum, et al.'s U.S. Pat. No. 7,148,414, for “Colored music notation system and method of colorizing music notation”, which uses the same color for accidental tones [that is, notes not belonging to the key signature at a given time] as it does for tones which belong to the scale. In the system which will be described in this application, the multi-colored embodiment colors every pitch in a given octave with a different color. Furthermore, it does so using a color set which closely follows the natural order of the visible spectrum of light. In U.S. Pat. No. 7,439,438, Hao proposes a keyboard notation system which employs only 2 colors of “pitch strips” and continues to display rhythm horizontally.

There have been numerous attempts to offer alternative staff displays, such as a staff with a greater number of lines, or a “chromatic staff” such as can be seen at http://musicnotation.org/, yet none of these display pitches on a “keyboard chart”. There exists also a method which goes by various names and is known generally as piano roll notation, as seen here: http://hiphop-producer.com/how-to-play-still-dre-on-piano-with-notes/. Although employing a type of keyboard chart with rhythmic shown in the visual length of notes, this system is read from left to right, does not employ color nor shading for dynamic effects, nor does it include harmonic or theoretical analysis of the music.

Various systems of visually representing music, although not necessarily for the sake of music notation and reading music have used color in the music notation and precise length to represent rhythmic value of notes, such as the videos of Stephen Malinowski, at http://www.musanim.com/store/ and www.youtube/com/user/smalin. However, none of these examples offer the precise idea of this useful color set which will described in this document, nor do they have music where rhythm is displayed vertically on a keyboard chart and where dynamic levels [or volume of sound] are shown with changes in color saturation, not to mention further advantages of the proposed notation system which will be covered in the “Detailed Description” section of this application. Interestingly, after having conceived of the idea for this new notation system, the inventor [Noah Epstein] of this new notation system approached Mr. Malinowski personally to discuss collaboration on a music notation project to employ aspects of his work in music illustration and computer software to generate a music notation program. However, Mr. Malinowski thoroughly rejected such an idea and seemed unable to see the value of this system as a music notation method. Although it contains some features in common with Mr. Malinowski's method of visually illustrating music, it seems that he is doing this for aesthetic and other purposes, but not as a music notation nor does he wish to.

### DRAWINGS—FIGURES

I have included 5 visual illustrations in this application:

FIG. 1: An enlarged view of a blank keyboard chart in triple time [¾ time, to be exact]. This is a generic outline of the layout of a standard page of this notation system, with its various columns from left to right. The keyboard chart has intentionally been left blank. Imagining a simple chord progression and melody on the keyboard chart, Roman numerals have been provided in the harmony column to denote the various chords. Note that this is only one embodiment of the work as the harmonic and melodic analysis columns, for example, are not essential to the function of this notation system.

FIG. 2: An example of colored notes in a scale in C-major for the right hand with colored fingerings shown as well.

FIG. 3: The first page of the “Moonlight” Sonata [op. 27 no. 2] by Ludwig van Beethoven, written in the standard notation system of today. Taken from a public domain download from the “Mutopia Project” at http://www.mutopiaproject.org/cgibin/piece-info.cgi?id=276. This has been included for comparison with FIG. 4, and the same amount of music as is shown in FIG. 4 has been highlighted in yellow highlighter here in FIG. 3.

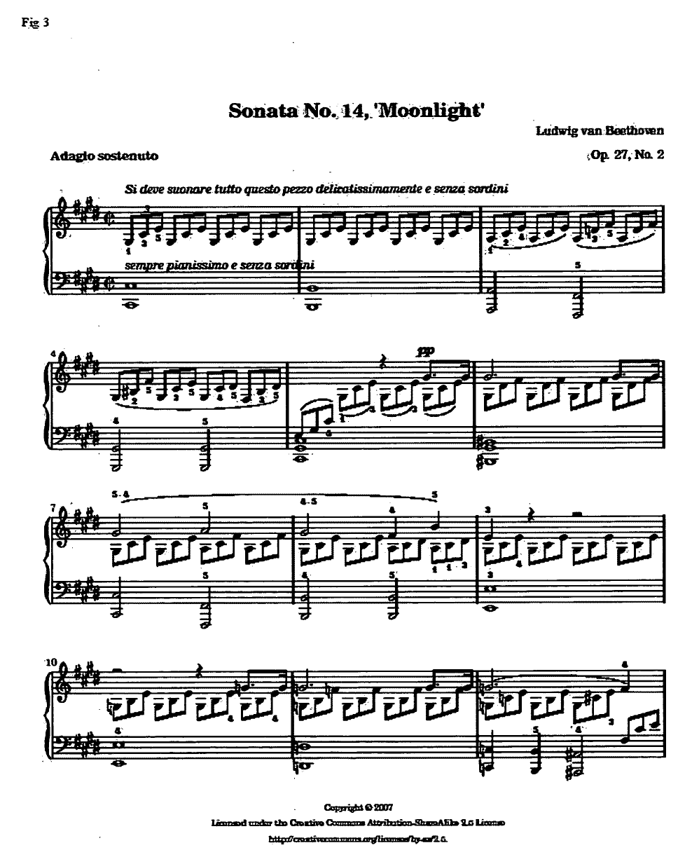

FIG. 4: The first 3 bars of the “Moonlight” Sonata op. 27, no. 2 by Ludwig van Beethoven, notated in this new notation system, displaying the colored pitches and rhythmic note-length. This is displayed in the standard layout of the notation system, without extras such as the left and middle pedal columns on the far left of the page. Note how the notes which are held down for an extended period fade in color as their sound also fades, for example with the two purple notes at the upper left of the keyboard chart which form a c-sharp octave in the left hand.

FIG. 5: A representation of the same passage which is displayed in FIG. 4, only in this case, extra features of the notation system are displayed, such as the sustain pedal column and the harmonic analysis column. These extra features are those which would be found in a certain alternative embodiments. However, this piece does not illustrate the left and middle pedals as they are not usually used in pieces of music.

Note that the melodic analysis space along the right edge of the page has been left blank as there really is no melodic activity to analyze in this passage. Also note how the sustain pedal column to the left of the keyboard chart increases in its shading of red as it is depressed for it causes the sound to “blend,” and then returns to a light red after it is released and depressed anew. The two columns to the right of the keyboard chart denote the small-scale and large-scale form in this piece during this passage.

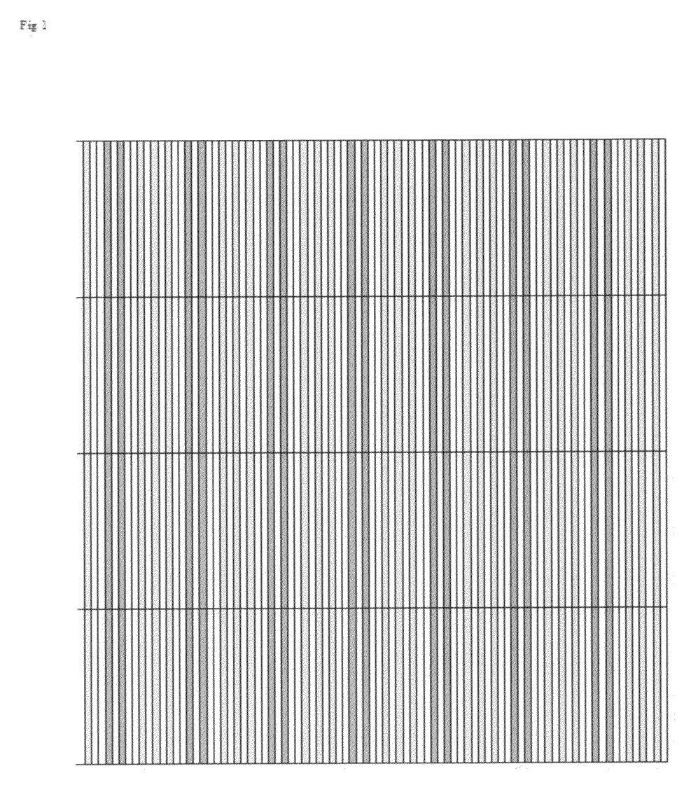

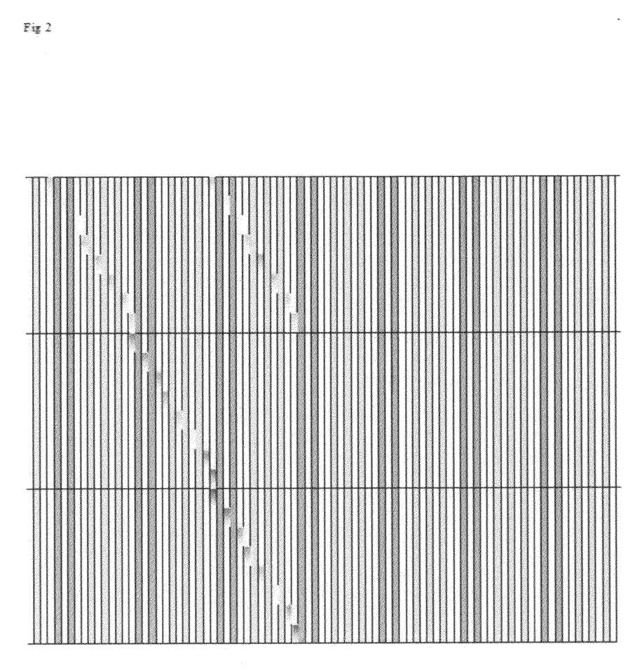

### DETAILED DESCRIPTION—FIGS. 1, 2,3, AND 4—FIRST EMBODIMENT

I, Noah Epstein, have conceived of a new system for notating music which makes many improvements on the current standard notation system for music. It is a system which uses a “keyboard chart” which is a view of the piano keyboard used to display musical notes, rather than writing note heads on a staff with lines and spaces. The keyboard chart displays notes from left to right on the page, going from low notes to high notes, displaying the full width of the standard 88-key piano in the first embodiment of this system. However, it is not necessary for an embodiment to display this full range for pieces which do not use the full range of the keyboard. Time and rhythm are displayed vertically, so the performer reads the score from the top down to the bottom, scanning left to right for notes to be played at any given instant. Below is a more detailed verbal explanation of the system.

Rhythm:

Rhythm is written in a way that is meant to be clear to even a beginner musician: notes which are to be held for a long time are given a long vertical height, while short notes are given a short height. This is done proportionally with precise measurements, as is explained in this quick example:

A piece of music is written in 4/4 time, with 60 beats per minute, thus each quarter note lasts for [approximately] one second. Let us imagine that it is decided that 2 vertical centimeters=1 quarter note. An eighth note would measure 1 centimeter. A sixteenth note would be 0.5 centimeter. A half note would be 4 centimeters tall, and so on proportionally, making precise measurements so that the height of a note corresponds exactly to its time value.

The result is that the music aligns clearly on the page. Notes which are to be played together align horizontally across the page. Each new measure would be announced with a horizontal black line cutting through the graph or keyboard chart, and each beat with a lighter gray line doing the same. Strong beats would have a darker gray line drawn across the keyboard chart to help show their accented rhythmic value. Depending on the time signature and velocity of the notes, there may also be a very light gray line drawn through each half-beat, all in the interest of making the page as orderly as possible for the performer. Down the left side of the keyboard chart, there will be numbers enumerating the beats and the break-down beats of a given bar of music. On the right column directly beside the keyboard chart, the numbers of the measures will be enumerated.

Grace notes [which are so quickly played that traditionally they are not notated as having any rhythmic value] and other short notes belonging to musical ornamentations can be notated in their exact rhythmic position, although this is not essential to the functioning of the notation system. For example, a grace note which decorates the first note of the beginning of measure 2 in a certain piece of music would be notated at the end of the last beat of measure 1, as that would show the exact moment when to correctly begin playing it.

Notes would also have a slight black bordering around them to help distinguish them from one another. For example, in a sequence of quickly repeated notes, all on the same piano key such as middle c, this border would help to show the separation of notes. This would show that middle c needs to be played again and again. Notes which are held over between bar lines would not have the black bar line cutting across their color. In fact, none of the horizontal lines on the keyboard chart [which show beats and break-down beats] would be drawn over the color of any played notes. These dark horizontal lines would be interrupted by the color of a played note and then resume being drawn across the page along those notes in the keyboard chart which are not being played. This is to help distinguish between held notes, repeated notes, and notes tied over across measures. Something which is important to make note of is that although the rhythmic value of a note is measured in proportion to other notes, this is done within a given tempo [i.e. beats per minute] of a piece of music. Importantly, this is not to say that a specific length in centimeters will always equal a certain rhythmic value of a note. So in an allegro [meaning “quickly”] passage of music, a quarter note may be 1 cm tall on the page and last for 1 second when it is played, and a half note would be 2 cm tall and last for 2 seconds. However, in a largo [very slow] passage a quarter note may be 2 cm tall, and a half note, 4 cm. Ideally, the slower the tempo of the piece of music [or a particular section of a given piece], the taller the vertical height of the basic beat will be, to give the feeling of how quickly the rhythm of the music moves along. Ideally, there will always be approximately the same number of seconds of music per page, regardless of the piece or the tempo. However, this will not always be done perfectly as, for example, with extremely fast passages [such as in “Flight of the Bumblebee”] this would cause too great a strain on the performer's eyes to see very short notes, and thus the vertical length of the beats would be extended. Also, with very slow pieces we would find that it would take several pages just to play a small number of notes and paper would be wasted. And so the rhythmic features of this notation system attempt to make all rhythmic beats within a given tempo be of proportional vertical height to one another, and for any given tempo to adjust the length of the rhythmic beats so that, within reason, regardless of the tempo of a piece, there will always be the same number of seconds of music displayed per page.

Pitch in Color, and with Dynamic Shading:

In the first embodiment, color would be used to show which note is being played [e.g.: C#, Eb, or B, etc.], and saturation of the color would represent the dynamic volume at which that note is to be played. Thus in a crescendo [which is a passage when the loudness of the music is increasing], for example, we would see the notes getting darker and darker in the shading of the color as we scan down the page. It would fade to a lighter color intensity during a decrescendo [decrease in loudness], all the while still maintaining the same basic color for each particular note. So for example, all of the C notes played in such a passage would be red, but some would be more deeply colored in than others. The colors themselves would not change throughout such passages, only the intensity of their shading, such as may be determined by the amount of ink used to color the note in the case of printed sheet music.

Let it be known that this notation system still functions without the use of various colors. However, for embodiments using color, the generic color set for the 12 notes will be the following, written here with precise HTML color code, at their highest dynamic level [ff and above]:

| | |
|---|---|
| C/B#/Dbb: red | FF0000 |
| C#/Db: dark red | 910000 |
| D/C##/Ebb: international orange | FF5900 |
| D#/Eb: orange | FFA500 |
| E/D##/Fb: yellow | FAFF00 |
| F/Gbb/E#: lime | 04FF00 |
| F#/Gb: aqua | 00FFE1 |
| G/F##/Abb: blue | 1000FF |
| G#/Ab: navy blue | 005DFF |
| A/G##/Bbb: indigo | 590091 |
| Bb/A#: Tyrian purple | 350028 |
| B/A##/Cb: magenta | FF00F6 |

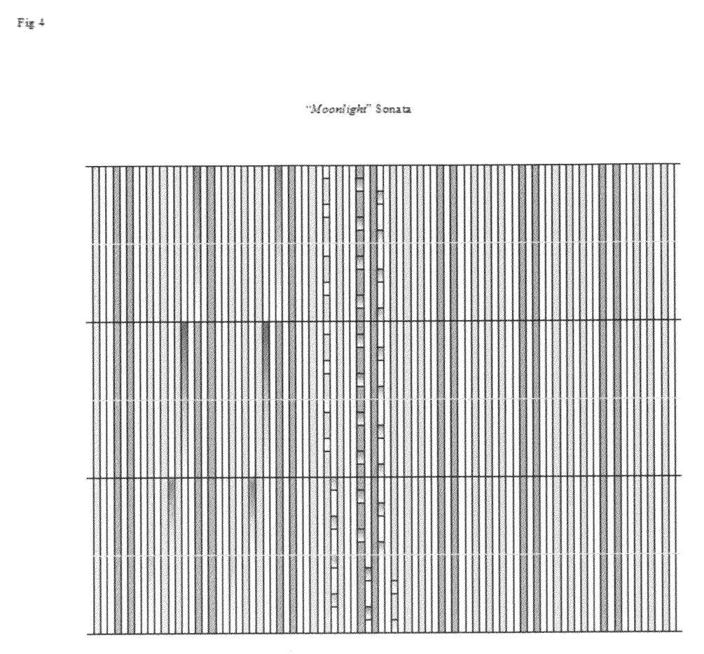

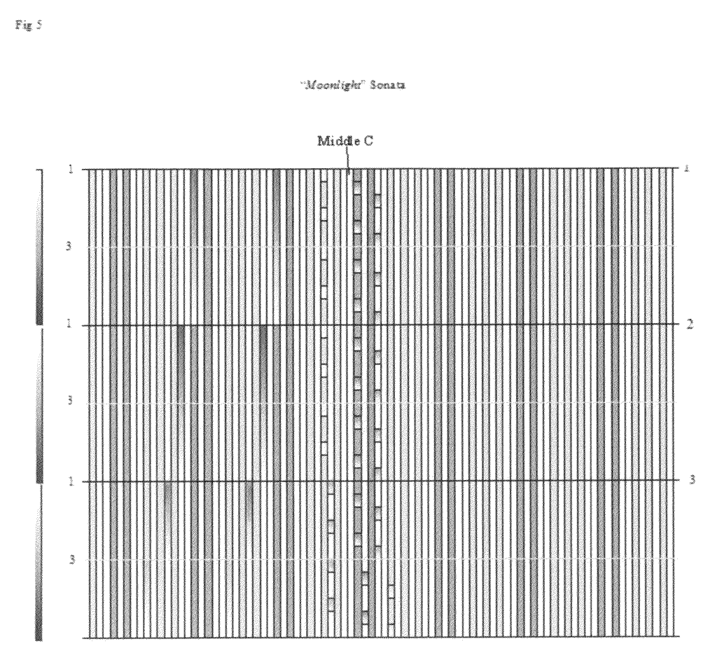

One very important note to make here is that this color set refers to precise pitches [e.g. C is always red] but there is also a way to use this notation so that it is scale degrees which are colored, and not absolute pitches. So for example, using this “solfa-scale” coloration, a piece in D major would have every D note colored in red, as D would be scale degree one. So this color set can be used as either a fixed or movable color set. It can be absolute in the sense that, for example, C is always red no matter what the key signature is, or it can be solfa-movable where it colors scale degree one in red, and scale degree two in orange, and so on, through all the colors of the color set. In minor keys, it would be a la-based minor [not a doh-based minor] so scale degree one in minor keys would be colored indigo, not red. Note that this is how FIGS. 4 and 5 are colored, using the solfa color set, with a la-based minor where c-sharp is scale degree one, whereas in FIG. 2 every C note is red and the scale follows absolute pitch coloration. Following a format for absolute pitch coloration, had FIG. 2 been a D major scale instead of a C major scale, the D notes would have been orange still and the E notes would have been yellow still, regardless of scale degree.

As will be explained below, dynamic level of the notes is dependant upon color saturation. From lowest volume to highest, these saturation percentages will be:
1. 60% for pp [pianissimo] and below.
2. 70% for p [piano].
3. 80% for “normal”, i.e. passages in which no dynamic level is marked.
4. 90% for f [forte].
5. 100% for ff [fortissimo] and above.

More advanced embodiments of this notation system may have more than 5 degrees of color saturation, representing various dynamic levels with greater precision. Black keys on the keyboard chart which are not being played will be shaded in light gray, not black, so that little attention is paid to them.

Articulations and Dynamics:

Articulations and dynamics will also be shown by the use of color and the way that rhythm is notated. Articulations, from quick staccato [or “detached”] notes to a smooth series of legato [that is, “connected”] notes, will be shown by a given note's rhythmic length. The rhythmic value and thus the vertical length of a note will show how long a note is to be played, so for connected legato notes, their full time length will be notated. For example, a series of legato quarter notes will fill in exactly a quarter note's length on the page. A series of staccato quarter notes will be considerably shorter, filling in roughly half the length of its actual beat value, as that is the only amount of time the note is to be played. So for example, a staccato quarter note will have a black border around the length of a standard quarter note [let us say 1 centimeter] but only half of that length will be filled in with color, and then suddenly it will be blank [or light grey, if the note was a black key on the keyboard chart].

There are other articulations of notes and this will be notated proportionally and logically within reason, still taking into account the performer's eyesight and the need to make approximate measurements at certain times. Semi-staccato notes will be colored in for an amount in between that of a staccatissimo [very short] note and that of a legato note of equal rhythmic value.

Color will also play a role in displaying further aspects of articulation, as color will vary in its intensity based on the loudness of a note. Soft notes will be only lightly colored, and very loud ones such as notes marked fortissimo [ff] will be very heavily colored. So a staccato note which is loud but is very quickly silenced will be colored in heavily and then suddenly be blank [or light grey, if that note was a black key]. Legato notes will be colored in and the color of the note will fade gradually as it comes to the end of its rhythmic value.

In this way, color will also describe the dynamic level or volume of the music. Loud passages will be entirely colored in with heavy coloration. Passages which undergo a crescendo [where there is a gradual increase in loudness] will begin with light coloration and soon become more and more heavily colored, while a decrescendo will illustrate just the opposite. Thus, there is less of a need for symbols like ‘pp’ for very soft, and ‘f’ for loud, nor for words like ‘legato’ and ‘staccato’ on the score. However, these may still be included in certain editions of this new sheet music, in hopes of aiding those musicians who can read today's existing music notation system to make a transition to the system described in this application. The first embodiment of this will have 5 degrees of dynamic shadings or levels of color saturation. As stated previously, from lowest volume to highest, these saturation percentages will be:
1. 60% for pp [pianissimo] and below.
2. 70% for p [piano].
3. 80% for “normal”, i.e. passages in which no dynamic level is marked.
4. 90% for f [forte].
5. 100% for ff[fortissimo] and above.

Further Details and Symbols:

There will be symbols along the top of each page to show which octaves are which. That is, a reference point will be given by indicating middle C, and every octave may be notated by counting the A notes on the piano: (A0, A1, A2, etc.).

Another novelty of this system is that it will use color to show which finger is used to play which note. This is not necessary for every note in a given piece of music, but may be included during difficult passages in the music. So the numbers which indicate the fingering will themselves be colored. The order will be 1[thumb]=Red, 2 [index finger]=Yellow, 3 [middle finger]=Green, 4 [ring finger]=Blue, 5 [fifth finger]=Pink, regardless of whether it is referring to the left hand or the right hand. In those cases where there is reasonable confusion as to which hand a certain number is referring to, the left and right hands may be referred to with the letters L and R, respectively. So, for example, the left thumb in such an instance would be notated as L1, in red characters.

The use of the pedals on a piano will be notated on the sheet music by the use of 3 columns to the left of the keyboard chart and to the left of the column of numbers which enumerate the rhythmic beats. These will show the left, center, and right pedals of the standard grand piano, which are the una corda, sostenuto, and sustain pedals, respectively. The sustain pedal is the pedal used most often, and will be drawn just to the left of the keyboard chart, whereas the other two pedals, if they are to be included at all in a given piece, will be drawn at the far left of the page, to the left of other columns of information.

If a pedal is to be depressed and held down, its otherwise blank column will become colored. For the sustain pedal, the color will begin in a light shade of red and then intensify to become darker [to the point of sometimes becoming dark brown] as the pedal is held down. If the pedal is to be released, the color will stop immediately, and a horizontal black line will be drawn across that particular pedal column and then it will be blank white again. The coloring of the una corda pedal and the center pedal will be shaded in at a constant intensity of color instead of getting gradually darker, since they do not cause the sound to blend and continuously change as the sustain pedal does. The colors for the pedal columns are:

Left pedal: yellow.
Center pedal: blue.
Right pedal: a range from light red to dark red or brown. A wavy line indicates to flutter the pedal by quickly depressing and releasing it multiple times.

Please note that it is possible to carry out the manifestation of this notation system in at least two ways. One, in simply drawing it out by hand with colored writing implements on graph paper, and the other way being to develop software to scan existing works of sheet music and convert them into this new notation format. The latter method is currently being developed privately by myself, the sole inventor of this notation system, Noah Epstein.

I will now list some of the advantages of this notation system:
Many people may be frustrated by the need to learn to read clefs [symbols which associate certain pitches with certain lines and spaces on a staff] and the arguably arbitrary conventions in the standard notation system of today, such as expanding the space around middle C on the grand staff between the treble and bass clefs. In fact, pianists need to learn to read two staves at once [one for each hand] in different clefs which is often a great difficulty for beginners. In the system which is the subject of this application, there is arguably less which needs to be learned by the performer to see which pitch is being displayed and how to play it, as it is drawn directly onto the picture of a keyboard with aids such as color, intensity of shading to indicate dynamic levels, and vertical height to indicate rhythmic value.
This system is not biased to the key signature of C-major or any particular key for ease of notation. There is no longer the need to learn the symbols of sharps and flats, nor will there be the difficulties of reading double-sharps and double-flats, as all notes will be drawn and colored directly on the keyboard chart. Also, if an accidental [a note not belonging to the key signature] occurs in a bar, there is no need to remember a symbol [called an “accidental” and symbolized by “#”, “b”, “bb”, etc.] to remind the performer of this, for if the note occurs again, it will simply be colored and displayed again.
This system distinguishes between a phrase [which is rather like a musical sentence] and a tie [which indicates to the performer to hold down a note for an extended period of time]. Both are notated with a curved line in standard musical notation, but in this new system, a tie is not necessary. Instead, the note which is to be held down simply stays colored until it is no longer to be held. Phrases are to be shown by the curved line as well as being implied by the brightness of the color of the notes which give shape to a phrase which crescendos and decrescendos, and the rhythmic pauses between notes which are already displayed in the score.
Music in this notation system can, arguably, be played without much knowledge of music theory, not even the rudiments of music theory as one no longer needs to learn key signatures, nor the symbols for accidentals on a page such as double sharps, nor clefs such as treble and bass, nor ledger lines which extend above and below the range of the ordinary staff, nor the different rhythmic values of note heads and flag lines.
One does not need to learn any symbols indicating rests in all their various rhythmic values, as silence is implied by the lack of color on a note.
The performer no longer needs to recall the conventions for how to notate the various intervals of a 2^{nd}, be it major or minor.
Arguable, only some basic concepts of rhythm and time signature and some basic guidance would be needed by a beginner performer. For a musician who has been trained in the standard notation system, adjusting to this new system should, theoretically, not be any great difficulty as many aspects of this new notation system are meant to be intuitive to the performer and certain old aspects are carried over.
To notate music for other instruments or combinations of instruments on this keyboard chart would be useful, and would give a universal standard for notation which musicians could agree upon. This elimination of clefs may be of great help to guitarists for example, who need to study piano music in a music theory course, but would be unfamiliar with reading two different clefs at once.
There are many features to this new system which arguably facilitate the reading, learning and memorization of a work of music. Different colors associated to the notes of the octave will help reinforce musical hearing abilities to the point that many skilled musicians may eventually be able to sit down with a score, away from their instrument, and sight-sing the music, even “hearing” it mentally. A theoretical analysis of harmony and form directly on the page will hopefully help a performer to learn and absorb principles of voice-leading, harmonic progression and small to large-scale musical structure which is not immediately apparent to many when looking at a work in today's existing notation system.
The vertical length of a note, representing time value of a note, in this notation can vary depending on the tempo at any given time. This aims to help the performer to see the relative time value of beats. For example, a quick piece marked allegro which starts out with 1 quarter note=1 centimeter, and then slows down for a passage suddenly marked poco adagio [which is very slow] may have the quarter note beats stretch out to 4 centimeters in length. This allows the eyes of the performer to always be scanning down the page at approximately the same rate at all times, regardless of the tempo of the music.
Giving precise measurements for time values allows an easier reading of rhythm as the eyes will be scanning down the page at almost always the exact same rate. Of course, for the sake of rationality, if a passage of extremely quickly played notes occurs, then a measure may need to be stretched or vertical height increased to accommodate all the notes so they are readable for the average eyesight. Alongside this, there could be a side note explaining the stretch of the vertical length of the beats in that passage. Regarding the opposite case, long passages of extremely slow notes may be compressed in vertical length so as not to waste paper with the printed sheet music.
Employing color to illustrate the individual semitones of the keyboard makes sight-reading easier, as one will often be able to recognize intervals at a glance by simply noticing the colors of them. For example, a passage playing several parallel octave intervals outlining a C-major chord [C, E, G] in the right hand will be easily recognizable as being octave intervals, since both the upper and lower notes of the octave will be the same color. This is because the low C and high C are the same color and the same goes for the E and its higher octave E, and for the G as well.
The notation system as a whole attempts to present music in a form which is as clear as possible, without the use of symbols which have to be mentally translated [albeit sometimes quite rapidly] by the performer. It attempts to be simple and clear while at the same time not sacrificing any aspect of the music which could be conveyed in another notation system. It aims to be so simple that many beginners may be able to sit down with the “Moonlight” Sonata by Ludwig van Beethoven and begin to play its opening bars rather well.
Using color saturation to display sound volume means that the system can notate a crescendo on a single note such as when a singer holds a pitch, getting constantly louder.
Instrumentalists using this notation system to read music for an instrument other than piano will pick up an increased knowledge and familiarity with the keyboard and this may help their skills in music theory and general musicianship as the keyboard is such a universal instrument. It is rather common for university students of music, regardless of their instrument, to be required to study keyboard skills for a music degree.
Duets and pieces for more than one performer at the piano can often be notated on one keyboard chart, as can choral works for Soprano, Alto, Tenor, Bass [SATB] and other combinations, including string quartets and other chamber music, and theoretically for many works of classical music. This feature of having several instruments notated on a single keyboard chart helps each musician to follow along with what the other musician[s] may be doing at the same time, to keep in rhythm with one another.
Notating orchestral scores in this new system would mean having many instruments on a single keyboard chart [or perhaps 2 adjacent keyboard charts on each page]. This aims to make sight-reading from full orchestral scores much easier for pianists.
The aspect of employing color for sound volume [loudness] can also clearly show when two different lines, perhaps a melody line in the left hand and another in the right hand, are both changing in volume, but in different ways. One is getting louder and thus darker in color, while the other is getting softer and thus lighter. This would be illustrated clearly on the page by use of shading.

It is possible that there are more advantages to this system which have not been listed here but which are a feature of this notation system and not today's existing notation nor other alternative systems. The major points this new notation system attempts to provide and which other notation systems arguably lack in some aspect or altogether are the intuitive display of pitch, rhythm, dynamics, and articulations all notated with a certain economy of means.

### Description—Alternative Embodiments

Let it be known that it is not necessary to use a keyboard chart such as that of a 12-semitone octave for this notation system, for theoretically any pitch chart could be used in other embodiments of the invention, such as a chart resembling the 6 strings of a standard guitar. Furthermore, a keyboard chart displaying less than 88 keys may be used in an alternative embodiment. Let it also be known that the specific color set is not to be seen as a limiting factor in the diversity of embodiments of this notation system, as it could indeed be done with only one color for every note of the octave, or simply a black or grey shading for whichever note is to be played, or an entirely different set of colors be used, or color assigned to scale degree based on the solfa scale, and it would still arguably qualify as an embodiment of this notation system. This point regarding solfa scale degree coloration [as mentioned in FIG. 4, FIG. 5, and on pages 13 and 14] is quite an important point as a very important alternative embodiment of this notation system would indeed use color assigned to scale degree and not to particular notes. So for example, a piece in F major would have every F note [scale degree 1] colored red, and every G note [scale degree 2] colored orange, and so on through the color spectrum, whereas in G major every G note [scale degree 1] colored red, and every A note [scale degree 2] colored orange, and so on.

Let it be stated here that the features of color intensification for crescendo passages is again a feature of the system which must not be seen as essential or limiting to any embodiment thereof, nor should the rhythmic feature of elongating or contracting the vertical length of notes to signify the number of beats per minute of a certain passage or piece of music be seen as an essential quality of any embodiment of this notation system. Let it also be stated that the notation system in its vertical embodiment could be rotated 90 degrees counter-clockwise to make it so that rhythm is read from left to right and the keyboard chart extends in pitch from the bottom to the top of the page, however, this would simply be another embodiment of the subject of this patent application.

Diversity of Instruments:

This notation system can theoretically be used for any combination of instruments, not just solo piano, while still displaying notes on the keyboard chart, essentially in the manner described above. It could work for many options and combinations such as solo guitar music, voice and piano or violin and piano where the second instrument is perhaps notated on a second keyboard chart on the same page or adjacent page. It would also work for choral works, and more. Even full orchestral scores could be notated in this system where different sections of the keyboard are designated to different instrumental sections of the orchestra. Works for organ could use a symbol over a row of low notes of the piano to illustrate which of these notes are indeed pedal tones played by the feet, and differently-colored borders on various octaves of the piano could illustrate which manual [i.e. level of the multi-level organ keyboard] are intended to be played.

Analysis of Music on Scores:

Added features which will be further developed and possibly included on an alternate embodiment of the sheet music are the harmonic and theoretical analysis of the music, directly on the page. This could aid the performer in memorizing a piece by seeing its large-scale form [such as the exposition versus the development sections of a sonata movement] as well as seeing its harmonic analysis [showing, for example, which chords are being outlined in a given beat] and the melody which is being played. This will entail 3 further columns. On the left of the page, just to the left of the column for the sustain pedal, there will be a column which shows the harmony at any given time. This will be a column for writing the Roman numeral names for the chord being played at any time, such as a V chord. a vii chord. a ii⁷ chord, etc.

On the far right of the page, there will be several columns, also in color, which state the form and sections of a piece. This is the theoretical analysis of the music and displays the form, sections, and other theoretical aspects of a piece of music by use of color and layers of parentheses and/or colored borders, which aid in distinguishing, for example, large-scale observations such as “Exposition section of 1^{st} movement” from small-scale observations such as “Question” which describes the opening of a certain musical phrase. For example, it may have a long red column with an extending parenthesis which states “Exposition” at the beginning of a sonata, which becomes blue for the “Development” section and then finally green for the “Recapitulation”. Just to the left of the large-scale form column [found on the far right] there will be a column which shows subsections of those divisions of a piece—for example, first and second themes and then episodes which occur within the exposition. And slightly to the left of that subsections column, will be an even more specific breakdown of the piece, which denotes period structure and the different musical phrases which interplay in “question and answer”, contrasting phrases, and more. Confusing as this may all sound, it is merely the outline of what will be part of a future embodiment of this system, and will be illustrated more fully and clearly then.

Elements of form and theory can also be illustrated directly around the border of the keyboard chart with colored borders, and even borders upon borders. For example, the first theme in a sonata could have a red border around the chart within another red border representing that this is taking place within the exposition of the sonata. At the entrance of the second theme, the outer border remains red [as it is still the exposition section] but the inner border changes color, let us say to yellow, showing that a new theme has been introduced.

The use of colored borders on the notes themselves is another way in which analysis of the music can be done in an alternative embodiment of this notation system. For example, in the key of C major, any note belonging to a G chord in a certain passage where the harmony of a G chord is being conveyed, could have a colored border around it, in the color of the root of that G chord, which is the color blue. This would show that the particular note is part of the chord built on G. Neighbor tones, passing tones, appoggiaturas, and certain other melodic figurations would then be more apparent on the score as they would not have the colored border of the given harmony. Lacking a colored border, they would stand out as non-chord tones among the chord tones which naturally would have colored borders. In the case of a suspended tone which is carried over from one harmony to the next, it would stand out by retaining the colored border of its original harmony, and then when it resolves by moving to a chord tone of the current harmony, this would again be apparent as the chord tone would then share the same colored border as the other chord tone notes around it.

All of this may be covered more in-depth with the exact terms and colors to be used in a future Provisional Patent Application or Patent Application for this new method of theoretical analysis, but I state it here just to show that it has already been conceived of and may be added to the sheet music with relative ease.

There will also be space to the right of the keyboard chart for indicating the analysis of the melody and all elements of melodic figuration contained therein, such as characteristic skips, leaps of a certain interval, appoggiaturas, neighbor tones, changing notes, escape tones and so on.

Other Considerations:

Certain conventional symbols may also be carried over from the standard notation system, and used in the column for symbols and words. For example the hair pin symbols which show the increase and decrease of volume in a crescendo and subsequent decrescendo could be used, and would help those who are familiar with standard musical notation during their transition to this new system. There are many, many symbols to list from the modern notation system which may be carried over, at least temporarily into this new system so let us suffice it to say that they may be used. Symbols for ornaments like turns and mordents may be included, symbols for rolled chords and repeat symbols, etc, may all be used.

Although the description above contains many specificities, these should not be construed as limiting the scope of the embodiments but as merely providing illustrations of some of the presently preferred embodiments. For example, the pedal, harmony, and melody columns can be arranged in a different order from left to right on the page, and the circular dials indicating dynamics and tempo could use a different color scale than those offered herein. To offer another example, one might produce a notation system bearing great resemblance to the notation system which has been described in this application, but which has rotated the page 90 degrees counter-clockwise so that rhythm is read from left to right and the keyboard chart extends in pitch from the bottom to the top of the page, however, this would simply be another embodiment of the subject of this patent application and thus would be an infringement.

Thus the scope of the embodiments should be determined by the appended claims and their legal equivalents, rather than by the illustrated embodiments.

I claim:

1. A method for representing music in a notation system, comprising the steps of:
a.) musical notes on a pitch chart, where the rhythmic values of said musical notes at a given tempo are indicated by the vertical length of said musical notes on said pitch chart, and
b.) shading of said musical notes which either fades or increases to illustrate either the fading or increase in loudness of said musical notes,
whereby said notation system will arguably offer a substantially intuitive display for reading music, in comparison to the prior art for music notation.

2. The method of claim 1 wherein said pitch chart is a keyboard chart showing some amount of the 88-key range of the piano.

3. The method of claim 1 wherein the color of each of said musical notes within a given octave is different.

4. The method of claim 1 wherein said pitch chart is displayed horizontally so that lower pitches are displayed to the left of higher pitches, and said rhythmic values elongate said musical notes vertically.

5. The method of claim 1, further including designated sections for harmonic and melodic analysis along either side of said pitch chart, to be done using Roman numerals, words, and various symbols.

6. The method of claim 1, further including theoretical analysis of any piece of music alongside said pitch chart in a methodical system of layers of parentheses, borders and colors designating specific sections of musical form from large scale to small scale as well as colored borders on said musical notes themselves designating which chord or aspect of melodic figuration said musical notes belong to.

7. A method for representing music in a notation system which displays musical notes in different shades on a pitch chart, where the shading of said musical notes either fades or intensifies to illustrate either the fading or increase in loudness of said musical notes.

8. The method of claim 7 wherein said musical notes within a given octave are of different colors.

9. The method of claim 7 wherein said pitch chart is a keyboard chart showing some amount of the full 88-key range of the piano.

10. The method of claim 7 wherein the rhythmic values of said musical notes at a given tempo are indicated by the vertical length of said musical notes on said pitch chart.

11. The method of claim 7 wherein said pitch chart is displayed horizontally so that lower pitches are displayed to the left of higher pitches.

12. The method of claim 7, further including designated sections for harmonic and melodic analysis along either side of said pitch chart, to be done using Roman numerals, words and various symbols.

13. The method of claim 7, further including theoretical analysis of any piece of music alongside said pitch chart in a methodical system of layers of parentheses, borders and colors designating specific sections of musical form from large scale to small scale as well as colored borders on said musical notes themselves designating which chord or aspect of melodic figuration said musical notes belong to.

14. A method for representing musical notes in a notation system, comprising the steps of:
a.) displaying musical notes in such a manner that each of said musical notes within a given octave is of a different color, and
b.) pitches on a pitch chart, where the rhythmic values of said musical notes at a given tempo are indicated by the vertical length of said musical notes on said pitch chart, and
c.) a display wherein said pitch chart is a keyboard chart showing some amount of the 88-key range of the piano,
whereby said notation system will arguably offer a substantially intuitive display for reading music, in comparison to the prior art for music notation.

15. The method of claim 14, further including designated sections for harmonic and melodic analysis alongside said pitch chart, to be done using Roman numerals, various words, and symbols.

16. The method of claim 14, further including theoretical analysis of any piece of music alongside said pitch chart in a methodical system of layers of parentheses, borders and colors designating specific sections of musical form from large scale to small scale as well as colored borders on said musical notes themselves designating which chord or aspect of melodic figuration said musical notes belong to.

17. The method of claim 14, wherein the shading of said pitches either fades or intensifies to illustrate either the fading or increase in loudness of said musical notes.

18. A method for representing musical notes in a notation system, comprising the steps of:
a.) pitches on a pitch chart, where the rhythmic values of said musical notes at a given tempo are indicated by the vertical length of said musical notes on said pitch chart, and
b.) displaying musical notes in such a manner that each of said musical notes within a given octave is of a different color, and
c.) a display wherein said pitch chart is a keyboard chart showing some amount of the 88-key range of the piano, and
d.) shading of said musical notes which either fades or intensifies to illustrate either the fading or increase in loudness of said musical notes,
whereby said notation system will arguably offer a substantially intuitive display for reading music, in comparison to the prior art for music notation.

19. The method of claim 18, further including designated sections for harmonic and melodic analysis alongside said pitch chart, using Roman numerals, various words, and symbols.

20. The method of claim 18, further including theoretical analysis of any piece of music alongside said pitch chart in a methodical system of layers of borders and colors designating specific sections of musical form from large scale to small scale as well as colored borders on said musical notes themselves designating which chord or aspect of melodic figuration said musical notes belong to.
